(19) United States
(12) Patent Application Publication
(10) Pub. No.: US 2017/0347051 A1
(43) Pub. Date: Nov. 30, 2017

(54) TRANSMISSION CONTROL METHOD AND DEVICE

(71) Applicant: FUJITSU LIMITED, Kawasaki-shi (JP)

(72) Inventors: Hiroshi KUWABARA, Suginami (JP); Taishi SOMEYA, Kawasaki (JP)

(73) Assignee: FUJITSU LIMITED, Kawasaki-shi (JP)

(21) Appl. No.: 15/581,232

(22) Filed: Apr. 28, 2017

(30) Foreign Application Priority Data
May 24, 2016 (JP) 2016-103383

(51) Int. Cl. H04N 5/38; H04N 7/08; G06F 1/16

(52) U.S. Cl. CPC H04N 5/38; H04N 7/08; G06F 1/1637; G06F 1/163; G06F 1/1686

(57) ABSTRACT

A method includes acquiring, from a camera, an image and capturing information indicating at least one of a capturing environment and a capturing status when the image is captured, determining whether to transmit the image to another computer based on the capturing information, and when it is determined that the image is transmitted to the another computer, transmitting the image to the another computer.

### CROSS-REFERENCE TO RELATED APPLICATION

This application is based upon and claims the benefit of priority of the prior Japanese Patent Application No. 2016-103383, filed on May 24, 2016, the entire contents of which are incorporated herein by reference.

### FIELD

The embodiments discussed herein are related to transmission control of information.

### BACKGROUND

Augmented reality (AR) technology in which an object is overlaid on a captured image using a display device, such as a head-mounted display, is proposed recently. In the AR technology, whether there are AR markers on continuously captured images is recognized using image processing, for example. The image processing involves a large amount of processing that depends on the number of pixels of the captured image, and power consumption also increases with the increase in the amount of processing. Therefore, measures to reduce power consumption are taken by reducing the number of pixels of the captured image, and lowering a frame rate, for example. Related technology is disclosed in Japanese Laid-open Patent Publication No. 2012-221260, No. 2008-046687, or No. 2007-304733, for example.

### SUMMARY

According to an aspect of the invention, a method includes acquiring, from a camera, an image and capturing information indicating at least one of a capturing environment and a capturing status when the image is captured, determining whether to transmit the image to another computer based on the capturing information, and when it is determined that the image is transmitted to the another computer, transmitting the image to the another computer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a transmission control system of a first embodiment;

FIG. 2 illustrates an example of a determination condition storage unit;

FIG. 3 illustrates an example of a camera configuration;

FIG. 4 illustrates an example of an object data storage unit;

FIG. 5 is a flowchart illustrating an example of a transmission control process of the first embodiment;

FIG. 6 is a block diagram illustrating an example of a configuration of a transmission control system of a second embodiment;

FIG. 7 is a sequence diagram illustrating an example of a transmission control process of the second embodiment; and

FIG. 8 illustrates an example of a computer which executes a transmission control program.

### DESCRIPTION OF EMBODIMENTS

Captured images to be acquired may include defocused images and images captured in a state where exposure, brightness, and other conditions are not favorable. In this case, if the captured images are subject to image processing, no AR marker is recognized and the image processing is unsuccessful. Therefore, power may be consumed unnecessarily.

In an aspect, technology disclosed in embodiments reduces power consumption during image transmission to an information processing apparatus.

Hereinafter, embodiments of a transmission control program, a transmission control method, and a transmission control apparatus disclosed by the present application will be described in detail with reference to the drawings. The disclosed technology is not restricted by the embodiments. The following embodiments may be combined in a range without inconsistency.

### First Embodiment

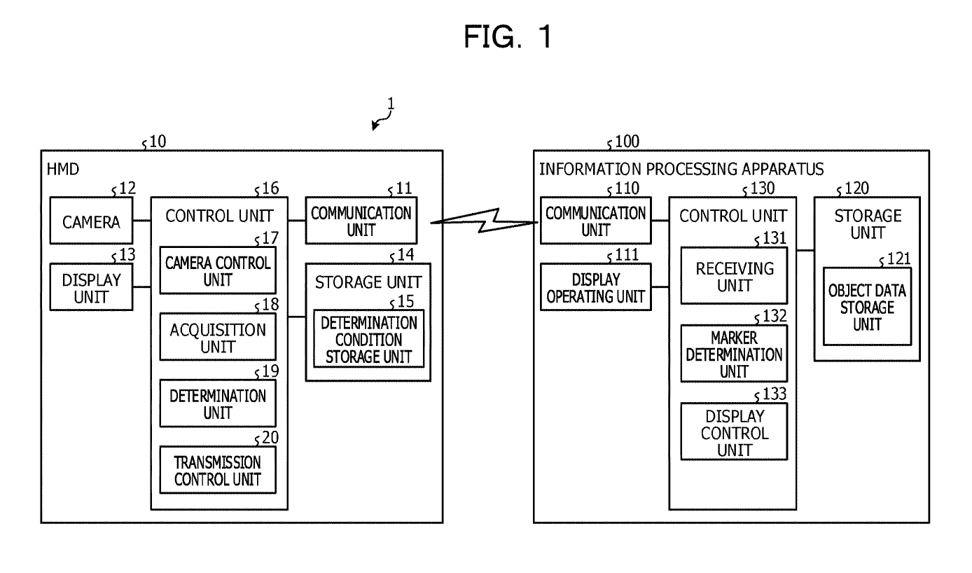

FIG. 1 is a block diagram illustrating an example of a configuration of a transmission control system of a first embodiment. The transmission control system 1 illustrated in FIG. 1 includes a head mounted display (HMD) 10, and an information processing apparatus 100. The HMD 10 and the information processing apparatus 100 are connected wirelessly on a one-by-one basis, for example. That is, the HMD 10 functions as an example of a display unit of the information processing apparatus 100. Although a set of the HMD 10 and the information processing apparatus 100 is illustrated as an example in FIG. 1, the number of sets of the HMD 10 and the information processing apparatus 100 is not limited, and an arbitrary number of sets of the HMD 10 and the information processing apparatus 100 may be used.

The HMD 10 and the information processing apparatus 100 are connected by a wireless local area network (LAN), such as the Wi-Fi Direct (registered trademark), for example, so as to communicate with each other. The HMD 10 and the information processing apparatus 100 may also be connected in a wired manner.

The HMD 10 is worn by a user together with the information processing apparatus 100, and displays a display screen transmitted from the information processing apparatus 100. The HMD 10 may be a monocular transmission HMD, for example. The HMD 10 may be any of various HMDs, such as a binocular HMD or an immersive HMD, for example. The HMD 10 includes a camera which is an example of an image capturing apparatus.

The HMD 10 acquires an image captured with the image capturing apparatus, and information indicating a capturing environment of the image capturing apparatus during capturing of the image. The HMD 10 determines whether the acquired captured image is set to be a transmission target based on the information indicating the acquired capturing environment. The HMD 10 transmits the captured image determined as a transmission target to the information processing apparatus 100 which determines whether a reference object with which AR content is to be correlated is included in the received captured image. Therefore, the HMD 10 can reduce power consumption during image transmission to the information processing apparatus 100.

The information processing apparatus 100 is an information processing apparatus which the user wears and operates, and may be a mobile terminal, such as a tablet terminal and a smartphone, for example. The information processing apparatus 100 determines whether a reference object with which AR content is correlated, for example, an AR marker, is included in the captured image received from the HMD 10 and accepted. If an AR marker is included in the captured image, the information processing apparatus 100 transmits a display screen in which object data corresponding to the AR marker, that is, the AR content is overlaid on the captured image, to the HMD 10, and makes the transmitted data be displayed.

Next, a configuration of the HMD 10 will be described. As illustrated in FIG. 1, the HMD 10 includes a communication unit 11, a camera 12, a display unit 13, a storage unit 14, and a control unit 16. The HMD 10 may further include functional sections, such as various input devices and audio output devices, for example, besides the functional sections illustrated in FIG. 1.

The communication unit 11 is implemented by a communication module, such as a wireless LAN, for example. The communication unit 11 is a communication interface which is wirelessly connected with the information processing apparatus 100 by the Wi-Fi Direct (registered trademark), and manages the communication of information between the information processing apparatus 100 and the HMD 10, for example. The communication unit 11 receives the display screen from the information processing apparatus 100. The communication unit 11 outputs the received display screen to the control unit 16. The communication unit 11 transmits the captured image input from the control unit 16 to the information processing apparatus 100.

The camera 12 is an image capturing apparatus which captures a reference object with which AR content is correlated, that is, an AR marker. The camera 12 captures an image using a complementary metal oxide semiconductor (CMOS) image sensor or a charge coupled device (CCD) image sensor, for example, as an image sensor. The camera 12 performs photoelectric conversion of light received by the image sensor, performs analog/digital (A/D) conversion, and generates a captured image. The camera 12 outputs the generated captured image, and information indicating a capturing environment including at least one of a focus control status, exposure, a gain, a brightness value (BV), and a color temperature to the control unit 16. The information indicating the capturing environment relates to image quality of the captured image. The camera 12 may include a flash using a light emitting diode (LED), for example.

The display unit 13 is a display device for displaying various types of information. The display unit 13 corresponds to, for example, a display element of a transmission HMD in which an image is projected on a half mirror so that a user can view the image with outside scenery through the half mirror. The display unit 13 may be a display element corresponding to an HMD of the immersion type, video transmission type, or retina projection type.

The storage unit 14 is implemented by a storage device, such as a semiconductor memory device, examples of which include random access memory (RAM) and flash memory. The storage unit 14 includes a determination condition storage unit 15. The storage unit 14 stores information used for the process in the control unit 16.

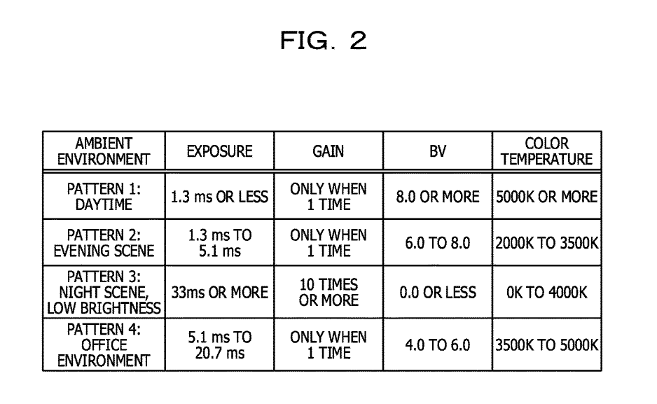

The determination condition storage unit 15 stores determination conditions used for the determination as to whether the captured image captured with the camera 12 is set to be a transmission target for the information processing apparatus 100. FIG. 2 illustrates an example of a determination condition storage unit. As illustrated in FIG. 2, the determination condition storage unit 15 includes items of “ambient environment,” “exposure,” “gain,” “By,” and “color temperature.” The determination condition storage unit 15 stores data for each ambient environment as one record, for example.

“Ambient environment” is information indicating an environment of the image to be captured. “Ambient environment” may have four patterns, for example. The four patterns may correspond to environments, for example, such as “pattern 1: daytime,” “pattern 2: evening scene,” “pattern 3: night scene and low brightness,” and “pattern 4: office environment.” “Exposure” is exposure time during capturing, that is, information indicating a shutter speed. “Gain” is information indicating an amplification degree of sensitivity in the camera 12. “By” is information indicating a value representing a brightness value (BV), that is, ambient brightness of an object to be captured. “Color temperature” is information indicating a color temperature during capturing.

Returning now to the description of FIG. 1, the control unit 16 is implemented when a program stored in an internal storage device is executed by a central processing unit (CPU) or a micro-processing unit (MPU), for example, using RAM as a workspace. Alternatively, the control unit 16 may be implemented by an integrated circuit, such as an application specific integrated circuit (ASIC) and a field programmable gate array (FPGA), for example.

The control unit 16 includes a camera control unit 17, an acquisition unit 18, a determination unit 19, and a transmission control unit 20, and implements or performs functions and effects of information processing described below. An internal configuration of the control unit 16 is not limited to the configuration illustrated in FIG. 1, but may be another configuration which performs information processing described below. When a display screen is input from the communication unit 11, the control unit 16 makes the display unit 13 display the input display screen.

The camera control unit 17 controls the camera 12. The camera control unit 17 acquires information indicating the capturing environment input from the camera 12. The camera control unit 17 performs control of the focus, control of the shutter speed, and control of flash light emission of the camera 12 based on the information indicating the acquired capturing environment. Each of the controls may be performed using a driver in the camera control unit 17. For example, a camera driver controls the shutter speed. An actuator driver controls the focus. A flash driver controls the flash light emission. The camera control unit 17 outputs the captured image input from the camera 12, and the information indicating the capturing environment to the acquisition unit 18. The captured image and the information indicating the capturing environment are continuously input from the camera 12 to the camera control unit 17, and the captured image and the information indicating the capturing environment may be handled as one frame in the following description.

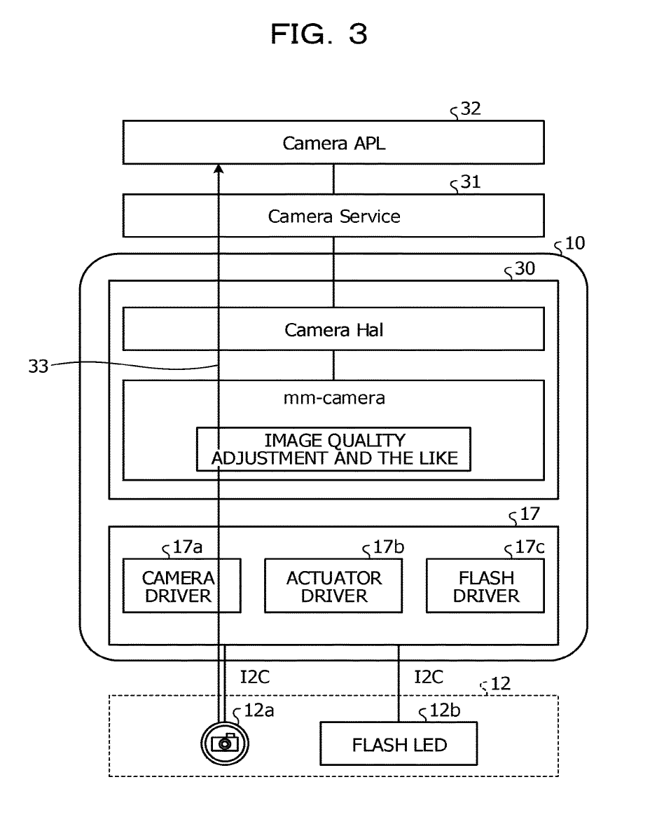

Here, a camera configuration will be described with reference to FIG. 3. FIG. 3 illustrates an example of a camera configuration. FIG. 3 schematically illustrates a flow to an AR application of a captured image captured with the camera 12. The camera 12 includes, for example, an image sensor 12a and a flash LED 12b which are connected to the camera control unit 17 with an I2C interface. The camera control unit 17 includes a camera driver 17a, an actuator driver 17b, and a flash driver 17c.

An image quality control unit 30 illustrated in FIG. 3 corresponds to the acquisition unit 18, the determination unit 19, and the transmission control unit 20. The image quality control unit 30 is, for example, implemented as a function of mm-camera or Camera Hal which adjusts image quality in Android (registered trademark) which is an operating system (OS). The image quality control unit 30 determines whether a captured image is set to be a transmission target based on information indicating a capturing environment input from the camera control unit 17. The image quality control unit 30 transmits the captured image of the transmission target to the information processing apparatus 100 via the communication unit 11. In the example of FIG. 3, a Camera Service 31 and a Camera APL 32 are examples of functions on the side of the information processing apparatus 100. In the information processing apparatus 100, the AR application can handle the captured image when the AR application uses the Camera APL 32. In FIG. 3, a flow of the captured image is indicated by an arrow 33.

Returning now to the description of FIG. 1, when a captured image and information indicating a capturing environment are input from the camera control unit 17, the acquisition unit 18 acquires the captured image and the information indicating the capturing environment. That is, the acquisition unit 18 acquires the captured image captured with the image capturing apparatus, and the information indicating the capturing environment when the captured image is captured with the image capturing apparatus. The acquisition unit 18 outputs the acquired captured image and the information indicating the capturing environment to the determination unit 19.

When the captured image and the information indicating the capturing environment are input from the acquisition unit 18, the determination unit 19 refers to the determination condition storage unit 15, and determines whether the captured image is set to be a transmission target based on the information indicating the capturing environment. The determination unit 19 determines whether a difference between the BV of the current frame and the BV of the previous frame is equal to or greater than 5, among the pieces of information indicating the capturing environments. If the difference between the BV of the current frame and the BV of the previous frame is equal to or greater than 5, the determination unit 19 determines that the captured image is not to be set as a transmission target, and waits for processing of a subsequent frame. That is, the determination unit 19 determines that a frame which is captured when an ambient environment is moved from a bright place to a dark place or from a dark place to a bright place is not to be set as a transmission target.

If the difference between the BV of the current frame and the BV of the previous frame is not equal to or greater than 5, the determination unit 19 refers to the determination condition storage unit 15 and determines an ambient environment. The determination unit 19 determines an ambient environment applicable to the BV and the color temperature in the determination condition storage unit 15 based on the BV and the color temperature among the pieces of input information indicating the capturing environments. The determination unit 19 refers to the determination condition storage unit 15 and reads a threshold of each item in accordance with the determined ambient environment. In an example of the first row of FIG. 2, if an input BV is “9.0” and an input color temperature is “8000K,” the determination unit 19 reads “1.3 ms or less” for the exposure, “only when 1 time” for the gain, “8.0 or more” for the By, and “5000K or more” for the color temperature as thresholds for determination.

After reading the threshold of each item in accordance with the ambient environment, the determination unit 19 makes a determination for each item with respect to the input information indicating the capturing environment. The determination unit 19 determines whether a focus control status among the pieces of information indicating the capturing environment is auto focus (AF). The focus control status indicates one of the states where AF is working in order to focus and where AF is stopped after completing the focusing. If the focus control status is a state where AF is working, the determination unit 19 determines that the captured image is not to be set as a transmission target, and waits for processing of a subsequent frame.

If the focus control status is a state where AF is not working, the determination unit 19 determines whether the exposure among the pieces of information indicating the capturing environment is within a range. If the exposure is not within a range, the determination unit 19 determines that the captured image is not to be set as a transmission target, and waits for processing of a subsequent frame. If the exposure is within a range, the determination unit 19 determines whether the gain among the pieces of information indicating the capturing environment is within a range.

If the gain is not within a range, the determination unit 19 determines that the captured image is not to be set as a transmission target, and waits for processing of a subsequent frame. If the gain is within a range, the determination unit 19 determines whether the BV among the pieces of information indicating the capturing environment is within a range. If the BV is not within a range, the determination unit 19 determines that the captured image is not to be set as a transmission target, and waits for processing of a subsequent frame. If the BV is within a range, the determination unit 19 determines that the captured image is a transmission target, and outputs the captured image to the transmission control unit 20.

When the captured image is input from the determination unit 19, the transmission control unit 20 transmits the input captured image to the information processing apparatus 100 via the communication unit 11. After transmitting the captured image, the transmission control unit 20 determines whether to end the transmission control process. When an operation to turn off a power button of the HMD 10 is received, for example, the transmission control unit 20 determines that the transmission control process is to be ended, and ends the transmission control process. When no operation to turn off a power button of the HMD 10 is received, the transmission control unit 20 determines that the transmission control process is not to be ended, and waits for processing of a subsequent frame.

Next, a configuration of the information processing apparatus 100 will be described. As illustrated in FIG. 1, the information processing apparatus 100 includes a communication unit 110, a display operating unit 111, a storage unit 120, and a control unit 130. The information processing apparatus 100 may further include various functional sections provided in known computers, such as functional sections of various input devices, and audio output devices, for example, besides the functional sections illustrated in FIG. 1.

The communication unit 110 is implemented by a communication module, such as a wireless LAN, for example. The communication unit 110 is a communication interface which is connected wirelessly with the HMD 10 by the Wi-Fi Direct (registered trademark), and manages the communication of information between the information processing apparatus 100 and the HMD 10, for example. The communication unit 110 receives a captured image from the HMD 10. The communication unit 110 outputs the received captured image to the control unit 130. The communication unit 110 transmits a display screen input from the control unit 130 to the HMD 10.

The display operating unit 111 is a display device for displaying various types of information, and an input device for receiving various operations from a user. The display operating unit 111 is implemented by a liquid crystal display as a display device, for example. The display operating unit 111 is implemented by a touch panel as an input device, for example. That is, the display device and the input device are integrated in the display operating unit 111. The display operating unit 111 outputs an operation input by the user to the control unit 130 as operation information. The display operating unit 111 may display the same screen as that of the HMD 10, or may display a different screen from that of the HMD 10.

The storage unit 120 is implemented by a semiconductor memory device, such as RAM and flash memory, or a storage device, such as a hard disk, and an optical disc, for example. The storage unit 120 includes an object data storage unit 121. The storage unit 120 stores information used for the process in the control unit 130.

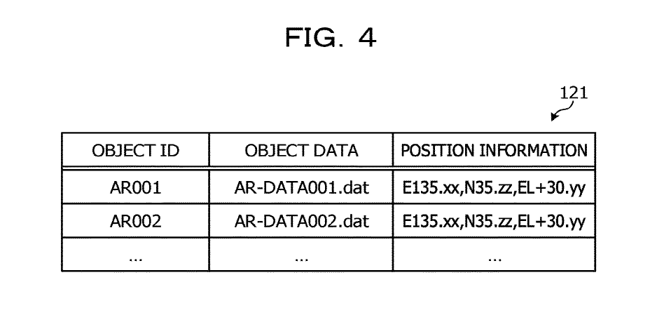

The object data storage unit 121 stores object data. FIG. 4 illustrates an example of an object data storage unit. As illustrated in FIG. 4, the object data storage unit 121 includes items, such as “object ID (Identifier),” “object data,” and “position information.” The object data storage unit 121 stores data for each object data as one record, for example.

“Object ID” is an identifier for identifying object data, that is, AR content. “Object data” is information indicating object data. “Object data” is a data file which constitutes object data, that is, AR content, for example. “Position information” is position information correlated with object data. “Position information” is information indicating position information in a world coordinate system of the correlated object data. “Position information” may be omitted if the AR marker and the object ID are correlated with each other.

The control unit 130 is implemented when a program stored in an internal storage device is executed by a CPU and an MPU, for example, using RAM as a workspace. The control unit 130 may be implemented by an integrated circuit, such as an ASIC and an FPGA, for example. The control unit 130 includes a receiving unit 131, a marker determination unit 132, and a display control unit 133, and implements or performs functions and effects of information processing described below. An internal configuration of the control unit 130 is not limited to the configuration illustrated in FIG. 1, but may be another configuration which performs information processing described below.

When a captured image is received from the HMD 10 via the communication unit 110, the receiving unit 131 accepts the received captured image. The receiving unit 131 outputs the received captured image to the marker determination unit 132.

When the captured image is input from the receiving unit 131, the marker determination unit 132 determines whether an AR marker is included in the captured image. That is, the marker determination unit 132 determines whether a reference object with which AR content is to be correlated is included in the received captured image. If an AR marker is included in the captured image, the marker determination unit 132 reads object data corresponding to the AR marker, that is, AR content, from the object data storage unit 121, and outputs the captured image and the AR content to the display control unit 133. If no AR marker is included in the captured image, the marker determination unit 132 outputs the captured image to the display control unit 133.

When the captured image and the AR content is input from the marker determination unit 132, the display control unit 133 generates a display screen in which the AR content is overlaid on the captured image. When the captured image is input from the marker determination unit 132 and no corresponding AR content is input, the display control unit 133 generates a display screen from the captured image. The display control unit 133 transmits the generated display screen to the HMD 10 via the communication unit 110 and makes the transmitted screen be displayed.

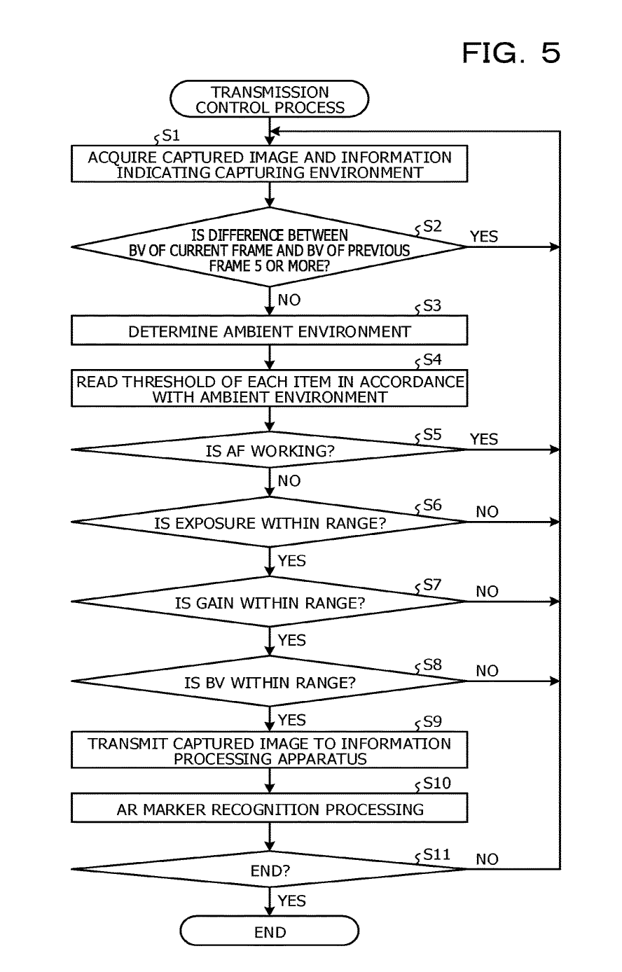

Next, an operation of the transmission control system 1 of the first embodiment will be described. FIG. 5 is a flowchart illustrating an example of a transmission control process of the first embodiment.

When power is turned on for the HMD 10 of the transmission control system 1 by the user, for example, the camera control unit 17 starts control of the camera 12, and outputs the captured image and the information indicating the capturing environment to the acquisition unit 18. When the captured image and the information indicating the capturing environment are input from the camera control unit 17, the acquisition unit 18 acquires the captured image and the information indicating the capturing environment (step S1). The acquisition unit 18 outputs the acquired captured image and the acquired information indicating the capturing environment to the determination unit 19.

When the captured image and the information indicating the capturing environment are input from the acquisition unit 18, the determination unit 19 determines whether a difference between the BV of the current frame and the BV of the previous frame is equal to or greater than 5, among the pieces of information indicating the capturing environments (step S2). If the difference between the BV of the current frame and the BV of the previous frame is equal to or greater than 5 (step S2: affirmative), the determination unit 19 determines that the captured image is not to be set as a transmission target, and returns to step S1.

If the difference between the BV of the current frame and the BV of the previous frame is not equal to or greater than 5 (step S2: negative), the determination unit 19 determines an ambient environment applicable to the BV and the color temperature in the determination condition storage unit 15 regarding the BV and the color temperature among the pieces of input information indicating the capturing environments (step S3). The determination unit 19 refers to the determination condition storage unit 15 and reads a threshold of each item in accordance with the determined ambient environment (step S4).

After reading the threshold of each item in accordance with the ambient environment, the determination unit 19 determines whether a focus control status among the pieces of information indicating the capturing environment is a state where AF is working (step S5). If the focus control status is a state where AF is working (step S5: affirmative), the determination unit 19 determines that the captured image is not to be set as a transmission target, and returns to step S1.

If the focus control status is a state where AF is not working (step S5: negative), the determination unit 19 determines whether the exposure among the pieces of information indicating the capturing environment is within a range (step S6). If the exposure is not within a range (step S6: negative), the determination unit 19 determines that the captured image is not to be set as a transmission target, and returns to step S1.

If the exposure is within a range (step S6: affirmative), the determination unit 19 determines whether the gain among the pieces of information indicating the capturing environment is within a range (step S7). If the gain is not within a range (step S7: negative), the determination unit 19 determines that the captured image is not to be set as a transmission target, and returns to step S1.

If the gain is within a range (step S7: affirmative), the determination unit 19 determines whether the BV among the pieces of information indicating the capturing environment is within a range (step S8). If the BV is not within a range (step S8: negative), the determination unit 19 determines that the captured image is not to be set as a transmission target, and returns to step S1.

If the BV is within a range (step S8: affirmative), the determination unit 19 determines that the captured image is a transmission target, and outputs the captured image to the transmission control unit 20. When the captured image is input from the determination unit 19, the transmission control unit 20 transmits the input captured image to the information processing apparatus 100 (step S9).

When the captured image is received from the HMD 10, the receiving unit 131 of the information processing apparatus 100 accepts the received captured image. The receiving unit 131 outputs the received captured image to the marker determination unit 132. When the captured image is input from the receiving unit 131, the marker determination unit 132 determines whether an AR marker is included in the captured image. When an AR marker is included in the captured image, the marker determination unit 132 reads AR content corresponding to the AR marker from the object data storage unit 121, and outputs the captured image and the AR content to the display control unit 133. That is, the marker determination unit 132 performs AR marker recognition processing (step S10). When no AR marker is included in the captured image, the marker determination unit 132 outputs the captured image to the display control unit 133.

When the captured image and the AR content is input from the marker determination unit 132, the display control unit 133 generates a display screen in which the AR content is overlaid on the captured image. When the captured image is input from the marker determination unit 132 and no corresponding AR content is input, the display control unit 133 generates a display screen from the captured image. The display control unit 133 transmits the generated display screen to the HMD 10.

When the display screen is received from the information processing apparatus 100, the control unit 16 of the HMD 10 makes the display unit 13 display the received display screen. After transmitting the captured image, the transmission control unit 20 determines whether to end the transmission control process (step S11). When the transmission control process is not to be ended (step S11: negative), the transmission control unit 20 returns to step S1. When the transmission control process is to be ended (step S11: affirmative), the transmission control unit 20 ends the transmission control process. Therefore, the HMD 10 can reduce power consumption during image transmission to the information processing apparatus.

The HMD 10 acquires the captured image captured with the image capturing apparatus, and the information indicating the capturing environment when the captured image is captured with the image capturing apparatus. The HMD 10 determines whether the acquired captured image is set to be a transmission target based on the information indicating the acquired capturing environment. The HMD 10 transmits the captured image determined as a transmission target to the information processing apparatus 100 which determines whether a reference object with which AR content is to be correlated is included in the received captured image. Therefore, power consumption during image transmission to the information processing apparatus 100 can be reduced.

The capturing environment in the HMD 10 includes at least one of ambient brightness of the image capturing apparatus, exposure of the image capturing apparatus, a gain of the image capturing apparatus, and a focus control status of the image capturing apparatus. Therefore, whether to set the captured image to be a transmission target can be determined based on the capturing environment.

The capturing environment in the HMD 10 is the image quality of the captured image. Therefore, whether the captured image is set to be a transmission target can be determined based on the image quality of the captured image.

### Second Embodiment

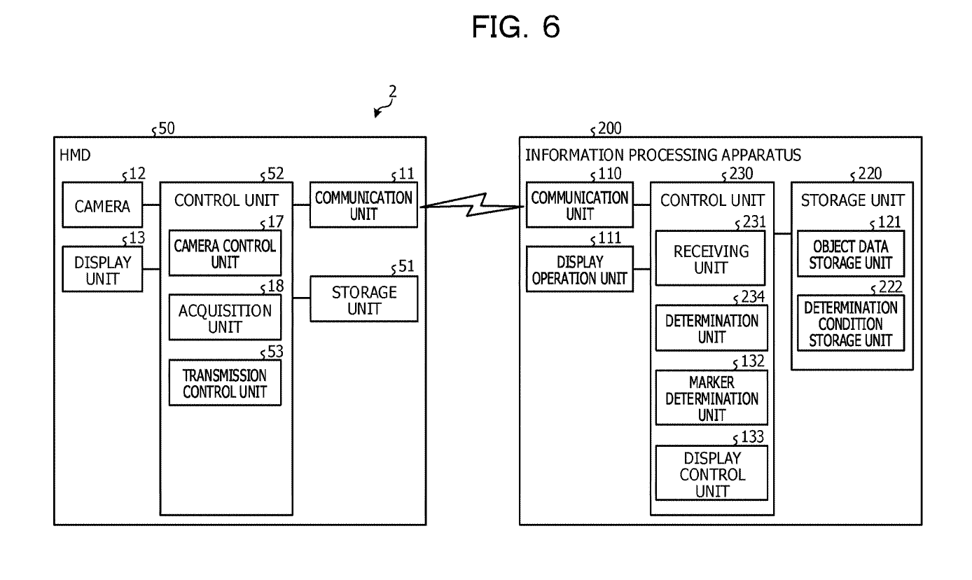

In the first embodiment, a filtering process to determine whether a captured image is set to be a transmission target is performed in the HMD 10. However, whether to perform image recognition on a captured image may be determined by the information processing apparatus 100. This embodiment will be described as a second embodiment. FIG. 6 is a block diagram illustrating an example of a configuration of a transmission control system of the second embodiment. The same configurations as those of the transmission control system 1 of the first embodiment are denoted by the same reference numerals, and repeated description of the configurations and operations is not given. A transmission control system 2 of the second embodiment includes an HMD 50 and an information processing apparatus 200 instead of the HMD 10 and the information processing apparatus 100 of the first embodiment.

A storage unit 51 of the HMD 50 in the transmission control system 2 of the second embodiment includes no determination condition storage unit 15 as compared with the storage unit 14 of the HMD 10 of the first embodiment. A control unit 52 of the HMD 50 includes no determination unit 19, but includes a transmission control unit 53 instead of the transmission control unit 20 as compared with the control unit 16 of the HMD 10 of the first embodiment.

When a captured image and information indicating a capturing environment are input from an acquisition unit 18, the transmission control unit 53 transmits the input captured image and the input information indicating the capturing environment to the information processing apparatus 200 via a communication unit 11. That is, the transmission control unit 53 transmits the input captured image and the input information indicating the capturing environment to the information processing apparatus 200 which determines whether a reference object with which AR content is to be correlated is included in the received captured image. The transmission control unit 53 determines whether to end in the same manner as the transmission control unit 20 of the first embodiment. In the second embodiment, the acquisition unit 18 outputs the acquired captured image and the acquired information indicating the capturing environment to the transmission control unit 53.

A storage unit 220 of the information processing apparatus 200 in the transmission control system 2 of the second embodiment further includes a determination condition storage unit 222 as compared with the storage unit 120 of the information processing apparatus 100 of the first embodiment. A control unit 230 of the information processing apparatus 200 further includes a receiving unit 231 instead of the receiving unit 131, and includes a determination unit 234, as compared with the control unit 130 of the information processing apparatus 100 of the first embodiment. Since the determination condition storage unit 222 is the same as the determination condition storage unit 15 of the first embodiment, description thereof is omitted.

When a captured image and information indicating a capturing environment are received from the HMD 50 via the communication unit 110, the receiving unit 231 accepts the received captured image and the received information indicating the capturing environment. The receiving unit 231 outputs the accepted captured image and the accepted information indicating the capturing environment to the determination unit 234. When an operation to turn off a power button of the information processing apparatus 200 is received, for example, the receiving unit 231 determines that the transmission control process is to be ended, and ends the transmission control process. When no operation to turn off a power button of the information processing apparatus 200 is received, the receiving unit 231 determines that the transmission control process is not to be ended, and waits for processing of a subsequent frame.

The determination unit 234 corresponds to the determination unit 19 of the first embodiment. When a captured image and information indicating a capturing environment are input from the receiving unit 231, the determination unit 234 refers to the determination condition storage unit 222, and determines whether the captured image is set to be a target of AR marker recognition processing based on the information indicating the capturing environment. The determination unit 234 determines whether a difference between a BV of the current frame and a BV of the previous frame is equal to or greater than 5, among the pieces of information indicating the capturing environments. If the difference between the BV of the current frame and the BV of the previous frame is equal to or greater than 5, the determination unit 234 determines that the captured image is not to be set as a target of AR marker recognition processing, and waits for processing of a subsequent frame. That is, the determination unit 234 determines that a frame which is captured when an ambient environment is moved from a bright place to a dark place or from a dark place to a bright place is not to be set as a target of AR marker recognition processing.

If the difference between the BV of the current frame and the BV of the previous frame is not equal to or greater than 5, the determination unit 234 refers to the determination condition storage unit 222 and determines an ambient environment. The determination unit 234 determines an ambient environment applicable to the BV and a color temperature in the determination condition storage unit 222 regarding the BV and a color temperature among the pieces of input information indicating the capturing environments. The determination unit 234 refers to the determination condition storage unit 222 and reads a threshold of each item in accordance with the determined ambient environment.

After reading the threshold of each item in accordance with the ambient environment, the determination unit 234 makes determination for each item with respect to the input information indicating the capturing environment. The determination unit 234 determines whether a focus control status among the pieces of information indicating the capturing environment is a state where AF is working. If the focus control status is a state where AF is working, the determination unit 234 determines that the captured image is not to be set as a target of AR marker recognition processing, and waits for processing of a subsequent frame.

If the focus control status is a state where AF is not working, the determination unit 234 determines whether exposure among the pieces of information indicating the capturing environment is within a range. If the exposure is not within a range, the determination unit 234 determines that the captured image is not to be set as a target of AR marker recognition processing, and waits for processing of a subsequent frame. If the exposure is within a range, the determination unit 234 determines whether a gain among the pieces of information indicating the capturing environment is within a range.

If the gain is not within a range, the determination unit 234 determines that the captured image is not to be set as a target of AR marker recognition processing, and waits for processing of a subsequent frame. If the gain is within a range, the determination unit 234 determines whether the BV among the pieces of information indicating the capturing environment is within a range. If the BV is not within a range, the determination unit 234 determines that the captured image is not to be set as a target of AR marker recognition processing, and waits for processing of a subsequent frame. If the BV is within a range, the determination unit 234 determines that the captured image is a target of AR marker recognition processing, and outputs the captured image to a marker determination unit 132. In the second embodiment, the captured image is input from the determination unit 234 to the marker determination unit 132.

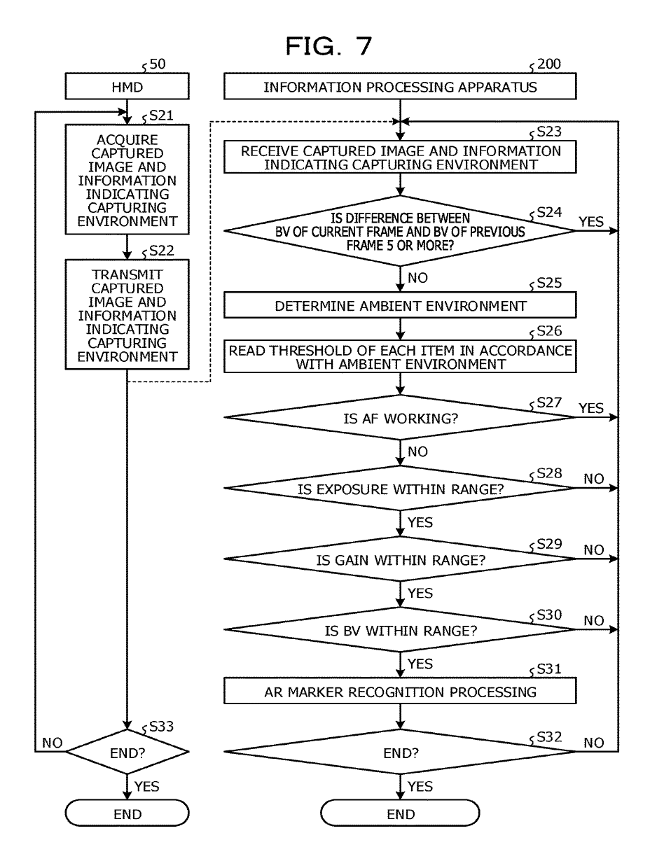

Next, an operation of the transmission control system 2 of the second embodiment will be described. FIG. 7 is a sequence diagram illustrating an example of a transmission control process of the second embodiment.

When power is turned on of the HMD 50 of the transmission control system 2 by a user, for example, a camera control unit 17 starts control of a camera 12, and outputs a captured image and information indicating a capturing environment to the acquisition unit 18. When the captured image and the information indicating the capturing environment are input from the camera control unit 17, the acquisition unit 18 acquires the captured image and the information indicating the capturing environment (step S21). The acquisition unit 18 outputs the acquired captured image and the acquired information indicating the capturing environment to the transmission control unit 53.

When the captured image and the information indicating the capturing environment are input from the acquisition unit 18, the transmission control unit 53 transmits the input captured image and the input information indicating the capturing environment to the information processing apparatus 200 (step S22).

When the captured image and the information indicating the capturing environment are received from the HMD 50 (step S23), the receiving unit 231 of the transmission control system 2 accepts the received captured image and the received information indicating the capturing environment. The receiving unit 231 outputs the accepted captured image and the accepted information indicating the capturing environment to the determination unit 234. In step S23, the captured image and the information indicating the capturing environment are continuously received from the HMD 50.

When the captured image and the information indicating the capturing environment are input from the receiving unit 231, the determination unit 234 determines whether a difference between the BV of the current frame and the BV of the previous frame is equal to or greater than 5, among the pieces of information indicating the capturing environments (step S24). If the difference between the BV of the current frame and the BV of the previous frame is equal to or greater than 5 (step S24: affirmative), the determination unit 234 determines that the captured image is not to be set as a target of AR marker recognition processing, and returns to step S23.

If the difference between the BV of the current frame and the BV of the previous frame is not equal to or greater than 5 (step S24: negative), the determination unit 234 determines an ambient environment applicable to the BV and the color temperature in the determination condition storage unit 222 regarding the BV and the color temperature among the pieces of information indicating the capturing environments (step S25). The determination unit 234 refers to the determination condition storage unit 222 and reads a threshold of each item in accordance with the determined ambient environment (step S26).

After reading the threshold of each item in accordance with the ambient environment, the determination unit 234 determines whether a focus control status among the pieces of information indicating the capturing environment is a state where AF is working (step S27). If the focus control status is a state where AF is working (step S27: affirmative), the determination unit 234 determines that the captured image is not to be set as a target of AR marker recognition processing, and returns to step S23.

If the focus control status is a state where AF is not working (step S27: negative), the determination unit 234 determines whether the exposure among the pieces of information indicating the capturing environment is within a range (step S28). If the exposure is not within a range (step S28: negative), the determination unit 234 determines that the captured image is not to be set as a target of AR marker recognition processing, and returns to step S23.

If the exposure is within a range (step S28: affirmative), the determination unit 234 determines whether the gain among the pieces of information indicating the capturing environment is within a range (step S29). If the gain is not within a range (step S29: negative), the determination unit 234 determines that the captured image is not to be set as a target of AR marker recognition processing, and returns to step S23.

If the gain is within a range (step S29: affirmative), the determination unit 234 determines whether the BV among the pieces of information indicating the capturing environment is within a range (step S30). If the BV is not within a range (step S30: negative), the determination unit 234 determines that the captured image is not to be set as a target of AR marker recognition processing, and returns to step S23.

If the BV is within a range (step S30: affirmative), the determination unit 234 determines that the captured image is a target of AR marker recognition processing, and outputs the captured image to a marker determination unit 132. When the captured image is input from the determination unit 234, the marker determination unit 132 determines whether an AR marker is included in the captured image. If an AR marker is included in the captured image, the marker determination unit 132 reads AR content from the object data storage unit 121, and outputs the captured image and the AR content to the display control unit 133 (step S31). When no AR marker is included in the captured image, the marker determination unit 132 outputs the captured image to the display control unit 133.

When the captured image and the AR content is input from the marker determination unit 132, the display control unit 133 generates a display screen in which the AR content is overlaid on the captured image. When the captured image is input from the marker determination unit 132 and no corresponding AR content is input, the display control unit 133 generates a display screen from the captured image. The display control unit 133 transmits the generated display screen to the HMD 50.

When the display screen is transmitted to the HMD 50, the receiving unit 231 determines whether to end the transmission control process (step S32). When the transmission control process is not to be ended (step S32: negative), the receiving unit 231 returns to step S23. When the transmission control process is to be ended (step S32: affirmative), the receiving unit 231 ends the transmission control process.

When the display screen is received from the information processing apparatus 200, the control unit 52 of the HMD 50 makes a display unit 13 display the received display screen. After transmitting the captured image, the transmission control unit 53 determines whether to end the transmission control process (step S33). When the transmission control process is not to be ended (step S33: negative), the transmission control unit 53 returns to step S21. When the transmission control process is to be ended (step S33: affirmative), the transmission control unit 53 ends the transmission control process. Therefore, the information processing apparatus 200 can reduce power consumption during AR marker recognition processing.

The HMD 50 acquires the captured image captured with the image capturing apparatus, and the information indicating the capturing environment when the captured image is captured with the image capturing apparatus. The HMD 50 transmits the acquired captured image and the acquired information indicating the capturing environment to the information processing apparatus 200 which determines whether a reference object with which AR content is to be correlated is included in the received captured image. Then, whether to perform AR marker recognition processing is determined based on the information indicating the capturing environment on the side of the information processing apparatus 200. Therefore, power consumption during image transmission to the information processing apparatus 200 can be reduced.

In each of the above embodiments, the information processing apparatus 100 or 200 and the HMD 10 or 50 are described as user-worn devices, but these are illustrative only. For example, the display screen may be displayed on the display operating unit 111 of the information processing apparatus 100 or 200 which is a smartphone, for example, without using the HMD 10 or 50.

Each component of each illustrated part does not necessarily have to be physically configured as illustrated in the drawings. That is, the specific modes of separation or integration of each part are not limited to those illustrated in the drawings. Each part may be configured to be entirely or partially separated or integrated functionally or physically in an arbitrary unit depending on loads or usage. For example, the acquisition unit 18 and the determination unit 19 may be integrated. The illustrated process steps are not limited to the described order, but the steps may be performed at the same time or in a different order in a range which causes no inconsistency in the process content.

The various process functions performed in each device may be entirely or arbitrarily partially executed by a CPU (or a microcomputer, such as an MPU and a micro controller unit (MCU)). Various process functions may be entirely or arbitrarily partially implemented on a program analyzed and executed by a CPU (or a microcomputer, such as an MPU and a micro controller unit (MCU)), or implemented as wired logic hardware.

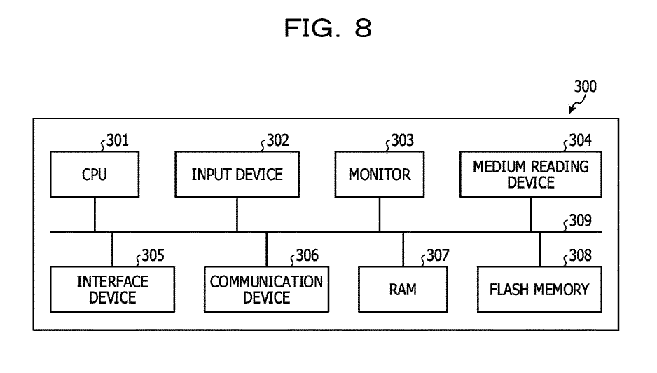

The various processes described in the above embodiments may be implemented by executing a previously-prepared program by a computer. Hereinafter, an example of a computer which executes a program having the same function as those of the above embodiments will be described. FIG. 8 illustrates an example of a computer which executes a transmission control program.

As illustrated in FIG. 8, a computer 300 includes a CPU 301 for executing various types of data processing, an input device 302 for receiving data input, and a monitor 303. The computer 300 further includes a medium reading device 304 for reading a program, for example, from a storage medium, an interface device 305 for connecting with various devices, and a communication device 306 for connecting with another information processing apparatus, for example, in a wired manner or a wireless manner. The computer 300 includes RAM 307 and flash memory 308 which store various types of information temporarily. The devices 301 to 308 are connected to a bus 309.

In the flash memory 308, a transmission control program having the same functions as those of the process units of the camera control unit 17, the acquisition unit 18, the determination unit 19, and the transmission control unit 20 or 53 illustrated in FIG. 1 or FIG. 6 is stored. In the flash memory 308, the determination condition storage unit 15 and various types of data for implementing the transmission control program are stored. The input device 302 receives input of various types of information, such as operation information from a user of the computer 300, for example. The monitor 303 displays various screens, such as a display screen, to the user of the computer 300, for example. A headphone is connected with the interface device 305, for example. The communication device 306 has the same function as the communication unit 11 illustrated FIG. 1, for example, and is connected with the information processing apparatus 100 or 200. The communication device 306 transmits and receives various types of information to and from the information processing apparatus 100 or 200.

The CPU 301 reads each program stored in the flash memory 308, develops and executes the read program on the RAM 307, and performs various processes. These programs may cause the computer 300 to function as the camera control unit 17, the acquisition unit 18, the determination unit 19, and the transmission control unit 20 or 53 illustrated in FIG. 1 or FIG. 6.

The transmission control program described above does not necessarily have to be stored in the flash memory 308. For example, the computer 300 may read and execute a program stored in a storage medium readable by the computer 300. The storage medium readable by the computer 300 may be a portable recording medium, such as a CD-ROM, a DVD disc, universal serial bus (USB) memory, semiconductor memory, such as flash memory, and a hard disk drive, for example. The transmission control program may be stored in a device connected with a public line, the Internet, a LAN, for example, and the computer 300 may read and execute the transmission control program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method executed by a computer, the method comprising:
acquiring, from a camera, an image and capturing information indicating at least one of a capturing environment and a capturing status when the image is captured;
determining whether to transmit the image to another computer based on the capturing information; and
when it is determined that the image is transmitted to the another computer, transmitting the image to the another computer.

2. The method according to claim 1, wherein
the another computer executes image processing to the image, and
the image processing includes:
detecting a reference object from the image, and
generating display information for controlling a display in the computer to display an object corresponding to the reference object when the reference object is detected from the image.

3. The method according to claim 2, further comprising:
receiving the display information from the another computer; and
displaying on the display the object correlated with a real space based on the display information.

4. The method according to claim 1, wherein the capturing information is information with which image quality of the image is predictable.

5. The method according to claim 4, wherein the capturing information includes at least one of ambient brightness of the camera, exposure of the camera, a gain of the camera, and a control status indicating whether the camera is under focus control.

6. The method according to claim 4, wherein the capturing information includes ambient brightness of the camera, exposure of the camera, and a gain of the camera.

7. The method according to claim 6, further comprising:
specifying a pattern of the capturing environment depending on the ambient brightness; and
acquiring a determination condition in accordance with the pattern, the determination condition being related to the exposure and the gain,
wherein the image is transmitted to the another computer when the exposure and the gain included in the capturing information satisfy the determination condition.

8. The method according to claim 7, wherein the capturing information further includes a control status indicating whether the camera is under focus control.

9. The method according to claim 8, further comprising:
determining whether the control status indicates that the camera is under focus control,
wherein the image is transmitted to the another computer when the camera is not under the focus control and the determination condition is satisfied.

10. The method according to claim 7, wherein the ambient brightness is indicated by a BV value.

11. The method according to claim 10, further comprising:
determining whether a difference between the BV value of the image and another BV value of another image captured before the image is less than a threshold value,
wherein the pattern is specified when the difference is less than the threshold value.

12. The method according to claim 3, wherein the computer is a head mounted display including the camera and the display.

13. A method executed by a computer, the method comprising:
acquiring, from a camera provided in another computer, an image and capturing information indicating at least one of a capturing environment and a capturing status when the image is captured;
determining whether image processing is performed on the image based on the capturing information; and
when it is determined that the image processing is performed,
detecting a reference object from the image,
generating display information for controlling a display in the another computer to display an object corresponding to the reference object when the reference object is detected from the image, and
transmitting the display information to the another computer.

14. A device comprising:
a memory; and
a processor coupled to the memory and configured to:
acquire, from a camera, an image and capturing information indicating at least one of a capturing environment and a capturing status when the image is captured,
determine whether to transmit the image to another computer based on the capturing information, and
when it is determined that the image is transmitted to the another computer, transmit the image to the another computer.

15. The device according to claim 14, wherein
the another computer executes image processing to the image, and
the image processing includes:
detecting a reference object from the image, and
generating display information for controlling a display in the computer to display an object corresponding to the reference object when the reference object is detected from the image.

16. The device according to claim 15, wherein the processor is configured to:
receive the display information from the another computer, and
display on the display the object correlated with a real space based on the display information.

17. The device according to claim 16, wherein the device is a head mounted display including the camera and the display.

18. The device according to claim 14, wherein the capturing information is information with which image quality of the image is predictable.

19. The device according to claim 18, wherein the capturing information includes ambient brightness of the camera, exposure of the camera, and a gain of the camera.

20. The device according to claim 19, wherein
the processor is configured to:
specify a pattern of the capturing environment depending on the ambient brightness, and
acquire a determination condition in accordance with the pattern, the determination condition being related to the exposure and the gain,
the image is transmitted to the another computer when the exposure and the gain included in the capturing information satisfy the determination condition.
